(19) United States
(12) Patent Application Publication
(10) Pub. No.: US 2016/0002476 A1
(43) Pub. Date: Jan. 7, 2016

(54) THREADED TUBULAR COMPONENT PROTECTED BY A FILM

(71) Applicants: VALLOUREC OIL AND GAS FRANCE, Aulnoye-Aymeries (FR); NIPPON STEEL & SUMITOMO METAL CORPORATION, Chiyoda-ku, Tokyo (JP)

(72) Inventors: Nicolas BREZIAT, Valenciennes (FR); Mikael PETIT, Villefranche Sur Saone (FR)

(73) Assignees: VALLOUREC OIL AND GAS FRANCE, Aulnoye-Aymeries (FR); NIPPON STEEL & SUMITOMO METAL CORPORATION, Chiyoda-ku, Tokyo (JP)

(21) Appl. No.: 14/768,812

(22) PCT Filed: Mar. 3, 2014
(86) PCT No.: PCT/EP2014/054090

§ 371 Date: Aug. 19, 2015

(30) Foreign Application Priority Data
Mar. 6, 2013 (FR) 1351998

(51) Int. Cl. C09D 5/08; C25D 7/04; F16L 15/08; C09D 175/04; F16L 58/10; C09D 5/00; C09D 133/00; B05D 1/02; F16L 57/00

(52) U.S. Cl. CPC C09D 5/08; B05D 1/02; C25D 7/04; F16L 15/08; F16L 57/005; F16L 58/1072; C09D 5/008; C09D 133/00; C09D 175/04; C09D 5/086

(57) ABSTRACT

A tubular component includes at least one threaded portion for connecting the component with a complementary component, wherein at least a portion of the threaded portion is coated with a strippable film which protects against corrosion. The film can be manually strippable. The film can be applied to a lubricating layer which has already been deposited on the surface of the threaded portion. The strippable film can be used to improve maintenance of mechanical properties of the threaded portion during storage thereof.

The invention relates to a means for protecting the threaded ends of tubular components, in particular tubular components for drilling or working hydrocarbon wells or the like, and more precisely for protecting the male or female ends of components of this type during periods of storage, which may last up to several years, during which period the ends of the components are not connected one with another. More particularly, the invention is of application to the field of metallic components to be protected from corrosion.

The term “component” as used here means any element or accessory used to drill or work a well and for connecting to another component via a threading in order to constitute a threaded tubular connection with that other component. The component may, for example, be a great length tube (in particular approximately ten metres in length), a tubular coupling a few tens of centimetres in length, an accessory for such tubes (a hanger, a cross-over, a safety valve, a tool joint, a sub or the like).

The components are generally connected to each other in order to be dropped into a hydrocarbon well or similar well and to constitute a drill stem, a casing or liner or tubing, or an operating string.

Specification API 5CT issued by the American Petroleum Institute (API), which is equivalent to ISO standard 11960: 2004 issued by the International Standardization Organisation (SO), sets out the specifications for tubes used as casing or tubing, and API specification 5B defines standard threadings for such tubes. API specification 7 defines threaded connectors with a shoulder for rotary drill stem elements.

The manufacturers of tubular components with threaded connections have also developed threaded connections known as premium connections which have threadings with a specific geometry, and specific means which provide them with better performances in service, in particular as regards the strength and seal. Examples of such premium threaded connections and of such specific means are described, for example, in the following patent documents: EP 1 631 762, U.S. Pat. No. 7,334,821, U.S. Pat. No. 7,997,627, U.S. Pat. No. 7,823,931, US-2010/301603, US-2011/0025051, U.S. Pat. No. 7,900,975, U.S. Pat. No. 8,038,179, US 2011/241340, EP-0488912, EP 0767335, EP-1269060 and U.S. Pat. No. 4,494,777, EP 2 501 974 and WO 2012/025461.

Such threaded ends are machined very precisely in order to comply with the required profiles and geometries in order to obtain the prescribed performances.

Thus, it is essential that these ends which have been machined so precisely and carefully should be damaged, polluted and deteriorated as little as possible from the time when they leave the production line to the time they are used, and also between two successive uses. It will be understood that in fact it is necessary to protect not only the threading against corrosion, dust and shocks (or knocks), but also any bearing surface(s) and abutment(s) which each have specific functions which are complementary to those of the threadings, and which together provide an effective seal when in use.

The ends of the components cited above are generally coated with an anti-corrosion grease which is removed just before connecting them. In fact, before such connection, the anti-corrosion grease is removed and replaced by a lubricating grease. However, prior art greases suffer from a certain number of disadvantages linked to their toxic constituent content, to the pollution they generate and to the number of steps that have to be taken before being able to drop a component into the well.

It is known from patent documents U.S. Pat. No. 6,027,145, EP 1 211 451 and EP 1 934 508 that a dry lubricant comprising lubricating solid particles can be applied at the factory. In these cases, when a dry lubricant is used at the factory, it is thus also necessary to protect, as best as possible, the layer of lubricating product with which the ends of the components are coated both from mechanical removal and from pollution (sand, debris) which are deleterious to the efficacy of the lubricating product.

Such layers of factory-applied product, then, are intended to provide anti-corrosion protection of the end during the storage period and lubrication for subsequent makeup of the threaded end as soon as that end has been manufactured, as is disclosed in particular in the documents WO 2004/033951 or WO 2008/125740. In particular, the lubrication should be capable of managing the characteristic curve of the makeup torque of the connection in order to guarantee the final seal.

The compositions used may be composed of a multi-functional coating which is both anti-corrosive and lubricating, like that described in WO 2008/125740 and applied to each end to be connected, or superimposed layers as described in WO 2004/033951, some of which are lubricating and others of which are corrosion-protective.

This notwithstanding, during makeup, the anti-corrosion elements are mixed with lubricating elements and will modify the lubricating behaviour which would have been obtained without them. It has often been demonstrated that the coupling between these functions is very strong and paradoxical. An improvement in the anti-corrosion behaviour of a design generally results in a deterioration of the lubricating power and conversely, an improvement in lubricating power reduces the corrosion resistance during storage. The compromises proposed by the prior art solutions have limited performances.

In fact, in order to improve the anti-corrosion performance, it is known to mechanically attach protective devices to provide a mechanical seal, as mentioned in the API specification 5CT, 8^{th} edition dated 1 Jul. 2005 (in paragraph 12.2) on the threaded ends covered with those compositions. Many protective devices of that type have been proposed, in particular in patent documents EP-0 148 807, U.S. Pat. No. 7,469,721, U.S. Pat. No. 7,284,770 or WO 2005/024282.

Further, there is a need for temporary protection of the threaded ends during phases at the factory which are between operations. As an example, in some cases, it is necessary to carry out a surface treatment of the threaded ends, for example sand blasting, or a conversion treatment such as phosphatization in order, for example, to improve the adhesion of the deposited coating.

Under certain conditions, several hours or even days might pass between the surface treatment and application of the coating or coatings. In that case, there is also a need for an alternative solution to using temporary protective oils. Such protective oils have the disadvantage cited above of having to be applied, in order to counter corrosion, at intermediate steps during the manufacture of the threaded end, then removed before placing the final coating with the required anti-corrosion and lubricating properties.

This time constraint may exist, for example, if the manufacture of the connection, for example comprising steps of machining and phosphatization, is not carried out at the same time as application of the coating. In fact, the techniques employed for these two actions are very different, and so they are not carried out in the same shops.

If the resulting roughness of the surface treatment is high (sand blasting), or the porosity is high (phosphatization), cleaning off such a temporary protective oil is complicated and difficult to carry out completely, and so the surface remains polluted by the temporary protective oil or the cleaning residues (water, solvent) before the coating is applied. The performance of the coating may be affected by it, especially its anti-corrosion performance due to defective adhesion to the threading.

At exploration or operational sites, there is also a need to protect tubes which are removed from the well when the connections have already undergone at least one makeup/breakout cycle. In fact, such tubes can be re-used, and there is a need to improve the conditions for their storage (rig return) in order to allow them to be re-used subsequently. Having undergone a makeup cycle, the coating(s) is (are) damaged by the effect of friction and high contact pressures in the connections. It is necessary to find a complementary and temporary solution to protection of these ends.

Thus, there is a need, at various times during the lifetime of a tubular component for oil exploration or operation, for protecting the threaded ends against corrosion for periods which vary in duration from a few hours to a few years, and to render the operations of application and removal of that protection against corrosion easier, more rapid, cheaper and less polluting, while being of comparable or better efficacy than that of storage greases and temporary protective oils, without the disadvantage of cleaning, which requires retrieving and re-applying such greases and oils.

Advantageously, there is a need for such a protection to be able to be applied then removed from a surface which has already been coated with a lubricating layer without changing the lubricating properties of that layer.

None of the known protective devices is entirely satisfactory, and so the purpose of the invention is to improve the situation.

The invention pertains to a removable corrosion-protective film. In particular, a film in accordance with the invention can be removed, preferably by manual stripping, but alternatively also by brushing or by dissolving.

More precisely, the invention concerns a tubular threaded component for drilling or working hydrocarbon wells, said tubular component having a threaded portion at one of its ends produced on its external or internal peripheral surface depending on whether the threaded end is male or female in type, this threaded end enabling the component to be made up with a complementary component, and wherein at least a portion of the threaded portion is coated with a strippable film which protects against corrosion.

Preferably, the tubular component comprises two threaded ends both covered with a strippable film which protects against corrosion, in order to allow storage of said component between its manufacture and its use on a drilled or operational well.

The term “strippable” means a capacity to be removed from its support. The term “strippable” corresponds to being capable of being removed. More particularly, the strippable film in the context of the invention may be manually removed at least in part.

The term “strippable” means being capable of being removed in the form of one or more solid pieces. In particular, a piece may have the form of “skin”, namely have a solid geometrical structure such that the largest dimension of the surface (length, diagonal or other) is very substantially larger than its thickness, for example at least 100 times, preferably at least 1000 times larger.

The term “strippable” means being capable of being detached at the interface with the support by exceeding an adhesion limit created between the film and the support, that adhesion being able to be defined by the formation of a chemical, physical or physico-chemical interaction, or by mechanical action. A covalent, metallic or ionic bond between the compounds of the film and the support may constitute a chemical interaction. An electrostatic, hydrogen or Van der Waals bond between the molecules of the film and the support may constitute a physical interaction. Cooperation between the film and the support obtained by elastic or elastoplastic deformation of the film may constitute a mechanical action.

A film in the context of the invention is solid. A film is a three-dimensional structure, not necessarily planar, with a thickness which is very substantially smaller than its other dimensions. A film corresponds to a thin foil of a substance covering a surface.

In practice, the support on which the strippable film may be deposited is a steel. More particularly in fact, the tubular components forming the subject matter of the present invention are produced from steel, in particular steels such as those described in the API 5CT standards, for example those comprising carbon in a proportion of less than 0.25% and/or preferably, steels with a grade as defined in ISO standards 11960 and 13680, and/or more precisely a H40, J55, K55, M65, L80, C90, C95, T95, P110, Q125 carbon steel or even a 13Cr or S13Cr, or Duplex 22Cr+25Cr or Super-Duplex 25Cr martensitic steel, or a Fe 27Cr austenitic steel.

Preferably, the strippable film can be obtained from a liquid precursor composition which comprises an aqueous dispersion of a film-forming polymer, the film-forming polymer being selected from natural or synthetic latexes, acrylic resins, acrylic copolymers such as styrene-acrylates, butadiene-acrylates, vinyl chloride-acrylates, polyvinylidene chloride-acrylates, vinyl acetate-acrylates, polyvinyl-styrene butadiene copolymers, polyvinyl butyrals, polyisocyanates, polycondensate type aliphatic polyurethanes such as anionic, cationic, non-ionic or amphoteric polyurethanes, acrylic polyurethanes, polyester-polyurethanes, and mixtures thereof.

In particular, the size of the particles of the film-forming polymer employed in the liquid precursor composition, this particle size being determined by laser granulometry, may be in the range 50 to 200 nm, such that the film which is formed has sufficient adhesion to the surface of the support and high water resistance.

Preferably, the quantity of film-forming polymer in the film after drying is in the range 60% to 90% by weight of dry film.

The strippable film may have a glass transition temperature in the range −10° C. to +35° C. The corrosion-protective strippable film may comprise an organic corrosion inhibitor, for example selected from an alkaline salt of an alkylarylsulphonic acid, the alkaline compound being a barium, a calcium, a magnesium or a sodium compound, or volatile organic nitrogen-containing molecules, in particular selected from an aliphatic amine (hexamethylene diamine, monoethanolamine), an amine carboxylate complex (monoethanolamine borate, cinnamic acid hexamethylenediamine, capric acid dicyclohexylamine, polyaspartic acid-imidazoline), a benzotriazole, an ammonium benzoate or a sodium nitrite, or an inorganic corrosion inhibitor, for example selected from a hydrated zinc and aluminium orthophosphate, a hydrated zinc and molybdenum orthophosphate, a hydrated strontium and aluminium polyphosphate, a hydrated zinc and calcium and strontium orthophosphate silicate, a zinc and iron phosphate, a zinc, calcium and strontium phosphosilicate, a zinc orthophosphate, an aluminium triphosphate, a zinc molybdate coupled with zinc phosphate-modified agents, a sodium molybdate, a calcium metaborate, a barium metaborate, a calcium borosilicate, a calcium ion exchanged silica, and mixtures thereof. The strippable film which protects against corrosion may comprise a mixture of ammonium benzoate and sodium sulphonate.

In practice, in addition to the barrier function of the film, the presence of corrosion inhibitor means that the corrosion resistance is improved.

The strippable film which protects against corrosion may comprise a volatile corrosion inhibitor designed to migrate towards the unprotected surfaces in order to create an invisible barrier, keeping moisture at a distance. A volatile corrosion inhibitor is an organic nitrogen-containing molecule with a high vapour pressure, namely 10 Pa or more at 20° C., which evaporates and becomes attached to the metallic surfaces in order to form a thin film a few molecules thick which is sufficiently hydrophobic and water-repellent to delay corrosion. The mechanism can be considered to be self-repairing.

As an example, the corrosion inhibitor may be included in proportions of 0.1% to 10%, preferably 0.1% to 5% of the liquid precursor composition weight. In particular, the corrosion inhibitor may be included in proportions of 0.1% to 13%, preferably 4% to 7% by weight of dry film.

In particular, the strippable film may comprise a thixotropic thickening agent, for example selected from a modified hydrophobic polyacrylate or a hydroxyethylmethylcellulose. The presence of such a thickening agent means that sedimentation and run-out in the storage and application phases when the liquid precursor composition is not subjected to any shear can be prevented. Advantageously, the thickening agent may be included in proportions of 0.1% to 2% of the liquid precursor composition weight.

As an example, the strippable film may comprise a mould release agent, in particular selected from a silicone polymer (polydimethylsiloxane, cyclopentasiloxane), a soya lecithin, or a fatty alcohol containing more than 18 carbon atoms, an alkyl phosphate ester, a perfluoroalkyl phosphate salt, an animal, vegetable or synthetic wax with a melting point in the range 50° C. to 150° C. such as an amide wax, a polyethylene wax or a glycerine. Advantageously, such a mould release agent may be included in proportions of 0.1% to 7.5%, preferably 0.1% to 2.5% of the weight of the liquid precursor composition. The proportion of unmoulding agent may be in the range 0.1% to 30%, preferably in the range 0.1% to 10% of the polymer weight.

Such a mould release agent contributes to limiting adhesion of the film to the support, and thus to providing improved strippability. In particular, the mould release agent composition may be adjusted in order to compensate for a strong elongation capacity of the film.

The strippable film may also comprise a plasticizing agent selected, for example, from the list formed by alkyl citrates, polyvinyl alcohols, polyglycols, celluloses and glycerol. Advantageously, such a plasticizing agent may be included in proportions of 1% to 5% of the weight of the liquid precursor composition in order to facilitate application and formation of the film on a support with a residual moisture.

The strippable film may also comprise a hydrosoluble polar solvent, in particular selected from methanol, butanol and isopropanol (IPA), in order to reduce the glass transition temperature of the polymer and consequently the film formation temperature, and also to facilitate wetting of the support. Advantageously, such a hydrosoluble polar solvent may be included in proportions of 5% to 30% of the weight of the liquid precursor composition.

Preferably, the strippable film comprises a colouring agent. Thus, it is visually easier to detect on the surface of the threaded portion. On the other hand, in the case in which the strippable film is removed in pieces, it is then easier to identify the pieces remaining on the threaded portion visually and to improve integral stripping of the film so that the characteristics of the threaded portion are not altered for the purposes of its subsequent connection.

As an example, the colouring agent may be selected from hydrosoluble or liposoluble dyes, pigments, nacres, materials with an optical effect and mixtures thereof. The term “pigments” should be understood to mean white or coloured, mineral or organic particles which are insoluble in an aqueous solution, intended to colour and/or opacify the resulting film. The pigments may be present in an amount of 0.0001% to 1% by weight with respect to the total weight of the liquid precursor composition.

Advantageously, the liquid precursor composition of the strippable film may also comprise anti-foaming agents in order to avoid the formation of bubbles in the film. In addition, this liquid precursor composition may also comprise a fungicide or a bactericide.

The liquid precursor composition of the strippable film may also comprise a surfactant, in particular a wetting agent and/or a dispersing agent, in order to homogenize the emulsion and the dispersion of the particles of polymers.

The strippable film may also have a tensile strength of more than 1 MPa, preferably more than 10 MPa.

The strippable film may have a breaking strength, also known as “elongation at break”, of more than 300%, preferably more than 700%, and more preferably more than 1000%.

Preferably, the strippable film may have a peeling resistance of less than 2 N/mm, in order to allow manual detachment.

Advantageously, the strippable film may also have a scratch resistance so as to protect the lower layer from friction marks from the protective end seals which might be kept on the threaded portion during storage thereof.

The invention also concerns a method for the preparation of a threaded end of a tubular component of the invention in which a strippable film is deposited by spraying a liquid precursor composition of the strippable film.

Preferably, the liquid precursor composition may be sprayed at a temperature in the range 5° C. to 35° C., preferably at a temperature of 10° C. to 15° C. higher than the glass transition temperature of the film, for example and advantageously in the range 20° C. to 40° C.

Advantageously, the spraying temperature of the liquid precursor composition may be selected so as to be substantially identical to the surface temperature of the tubular component.

Preferably, the film may be constituted by two layers of film produced from the same liquid precursor composition. In this case, the two layers are superimposed. Before forming the second layer, a minimum waiting period is necessary for coalescence and drying of the first layer; this waiting period may be 120 minutes or longer at 20° C. Advantageously, the drying temperature does not exceed 80° C. and is preferably in the range 5° C. to 35° C. A minimum drying period of 6 hours at 20° C. or a minimum of 15 minutes at 80° C. for a layer means that the elimination of residual water can be optimized and the properties of this film-forming layer can be guaranteed.

Prior to forming the strippable film and spraying the liquid precursor composition, the threaded portion is covered with a dry lubricating composition.

Advantageously, the invention concerns a tubular component which may comprise a dry lubricating composition forming a layer of lubricating coating disposed between the threaded portion and the strippable film.

In particular, the dry lubricating composition may comprise a “tackifying” resin, for example an aliphatic or aromatic rosin tackifying resin, or comprise an olefin copolymer, waxes, a viscous oil, a corrosion inhibiting pigment and solid lubricants, an alkaline-earth metal salt of an overbased sulphonic acid, a metallic soap, synthetic and vegetable waxes, lubricating solids and friction-modifying solids, one or more solid lubricating particles for reducing friction in a binding resin such as an organic or inorganic polymer which can be taken from the following list of epoxy, polyurethane, polyurea, unsaturated polyester, polyphenylsulphone, polyimide and silicone heat-cured resins, polyamide, polyamide-imide and polyaryletherketone thermoplastic resins and alkaline polysilicate resins with a SiO₂/MₓO weight ratio of more than 2 (M=Na, K or Li), organometallics such as ethyl silicate or alkoxytitanates, and mixtures thereof.

In some cases, the layer of lubricating coating may be solid. The lubricating coating may be applied using a hot melt method. It may also form a film.

As an example, such a dry lubricating composition may be selected from one of the compositions defined below (the proportions are given as % of the total dry lubricating composition weight):

### Composition No 1:

| | |
|---|---|
| Aliphatic rosin “tackifying” resin | 30% |
| Ethylene-vinyl acetate copolymer | 17% |
| Synthetic waxes such as a paraffin wax and | 17% |
| a hydrogenated castor oil | |
| Viscous oil such as a polydimethylsiloxane | 5% |
| Corrosion inhibiting pigment such as a | 10% |
| calcium ion exchange silica | |
| Lubricating solids such as Bi2Si3, PTFE | 20% |
| Antioxidants | 1% |

When composition No 1 is applied to a steel support, this support preferably undergoes a prior manganese phosphatization treatment.

### Composition No 2:

| | |
|---|---|
| Polyterpene “tackifying” resin | 30% |
| Aromatic rosin “tackifying” resin | 28% |
| Polystyrene - poly(ethylene-butylene)-b- | 18% |
| polystyrene block copolymer | |
| Plasticizer such as a polyol ester | 8% |
| Synthetic waxes such as a secondary amide | 10% |
| wax and a paraffin wax | |
| Viscous oil such as a polydimethylsiloxane | 5% |
| Antioxidants | 1% |

When composition No 2 is applied to a steel support, this support preferably undergoes a prior manganese phosphatization treatment.

### Composition No 3:

| | |
|---|---|
| Alkaline-earth metal salt of an overbased | 30% |
| sulphonic acid | |
| Metallic soap such as a zinc stearate | 15% |
| Synthetic wax such as a polyethylene wax | 20% |
| Vegetable wax such as a carnauba wax | 15% |
| Solid lubricants such as CFx, ZnO | 4.5% |
| Solid friction modifiers such as Bi₂O3, TiO₂ | 10% |
| Antioxidants | 1% |

When composition No 3 is applied to a steel support, this support preferably undergoes a prior treatment by electrolytic deposition of a ternary CuSnZn alloy comprising a Wood's nickel underlay.

### Composition No 4:

| | |
|---|---|
| Polyester acrylate (photocurable resin) | 20% |
| Epoxy acrylate (photocurable resin) | 15% |
| Monomers of a multifunctional methacrylate such | 45% |
| as tripropyleneglycol diacrylate and a | |
| trimethylolpropane triacrylate | |
| Photopolymerization initiators such as a 1-hydro- | 10% |
| cyclohexylphenyl ketone and a | |
| 2,2-dimethoxy-2-phenylacetophenone | |
| Passivating agent such as a benzotriazole | 1% |
| Corrosion inhibiting pigment such as an | 5% |
| aluminium phosphite | |
| Phosphate ester | 3% |
| Synthetic wax such as a micronized polyethylene wax | 1% |

When composition No 4 is applied to a steel support, this support preferably undergoes a prior zinc phosphatization treatment.

### Composition No 5:

| | |
|---|---|
| Polyterpene “tackifying” resin | 34% |
| Synthetic wax such as a secondary amide wax | 10% |
| Alkaline-earth metal salt of an overbased | 28% |
| sulphonic acid | |
| Ethylene-vinyl acetate copolymer | 12% |
| Viscous oil such as a polydimethylsiloxane | 5% |
| Solid lubricants such as Bi₂S₃, PTFE | 10% |
| Antioxidants | 1% |

When composition No 5 is applied to a steel support, this support preferably undergoes a prior manganese phosphatization treatment.

The feature “dry lubricant” means a composition which limits adhesion of solid pollutants or contaminants in a hostile environment which can influence friction during makeup, such as sand or dust.

The adhesion of solid contaminants is determined by means of a sand decontamination test. The test simply evaluates the temperature beyond which the dry lubricating composition can no longer be depolluted by means of pressurized air. The test consists of applying a layer of Dubai sand (density=1.6) to a predefined surface area of coating of a minimum of 60 cm², of exposing the ensemble to a given temperature for 1 hour in a ventilated oven, of depolluting using pressurized air at the given temperature and of evaluating the residual quantity of sand. A lubricating composition is considered to be dry if the temperature at which the residual quantity of sand is less than 0.5% is 40° C. or more, preferably 50° C. or more.

Prior to forming the strippable film, and if appropriate prior to depositing the dry lubricating composition, a surface treatment of the threaded portion may be carried out, either by mechanical sand blasting or by conversion by phosphatization with zinc or manganese, or by electrolytic deposition of a ternary CuSnZn alloy comprising an underlay of Wood's nickel.

Some features and advantages of the invention will now be discussed in more detail in the description below, made with reference to the accompanying drawings in which:

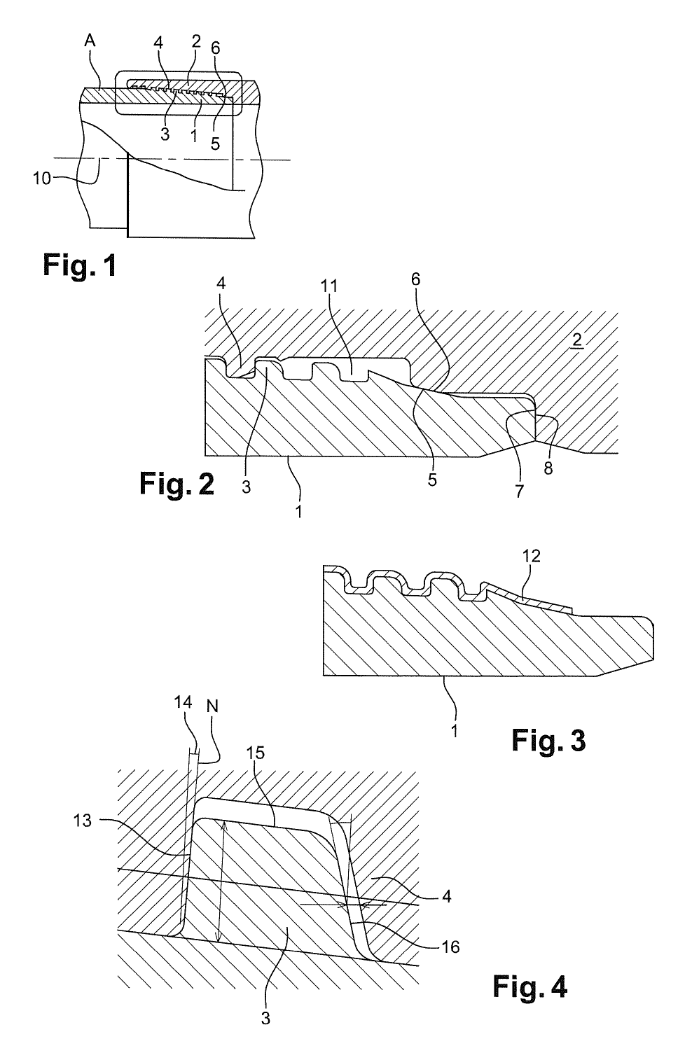

FIG. 1 is a schematic view of a connection resulting from making up two tubular components;

FIG. 2 is an enlarged view of the zone marked A in FIG. 1;

FIG. 3 is a schematic view of a threaded portion of a tubular component of FIG. 2 coated with a strippable film of the invention;

FIG. 4 is a detailed view of the cooperation between the threads of two connected tubular components;

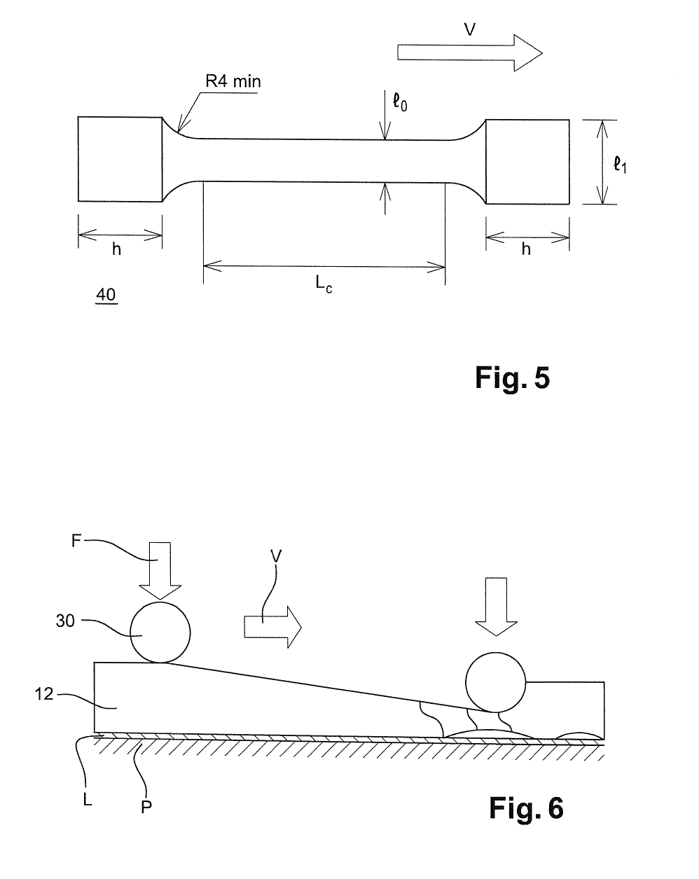

FIG. 5 is a schematic view of a tensile specimen used in accordance with the standard NF T 51-304 in the context of a tensile test;

FIG. 6 is a schematic view of equipment for carrying out a “scratch” test;

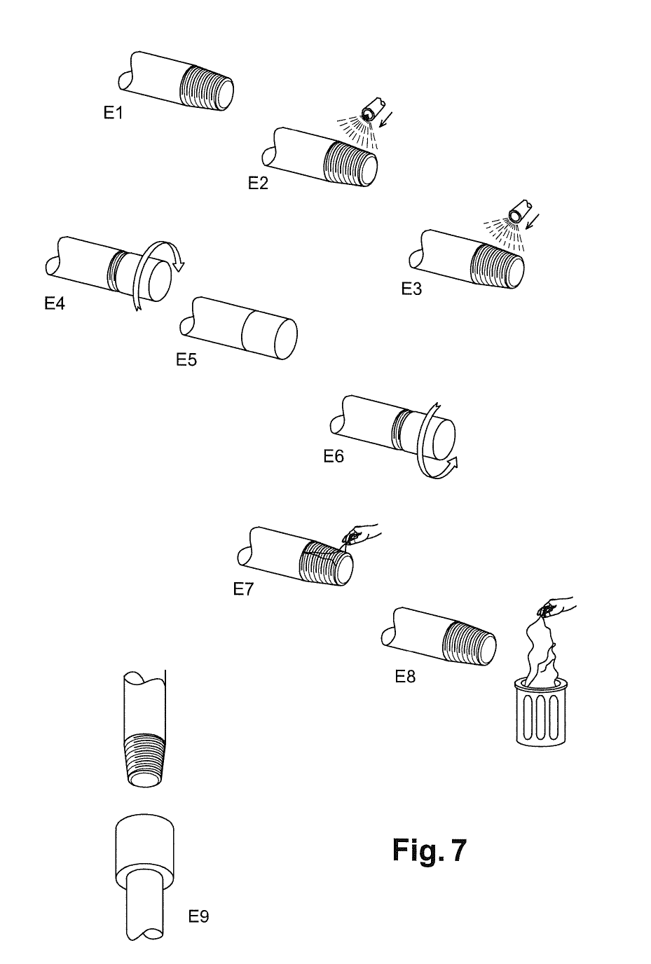

FIG. 7 represents the successive steps of protecting a threaded portion of a tubular component between its manufacture and its use at a production site;

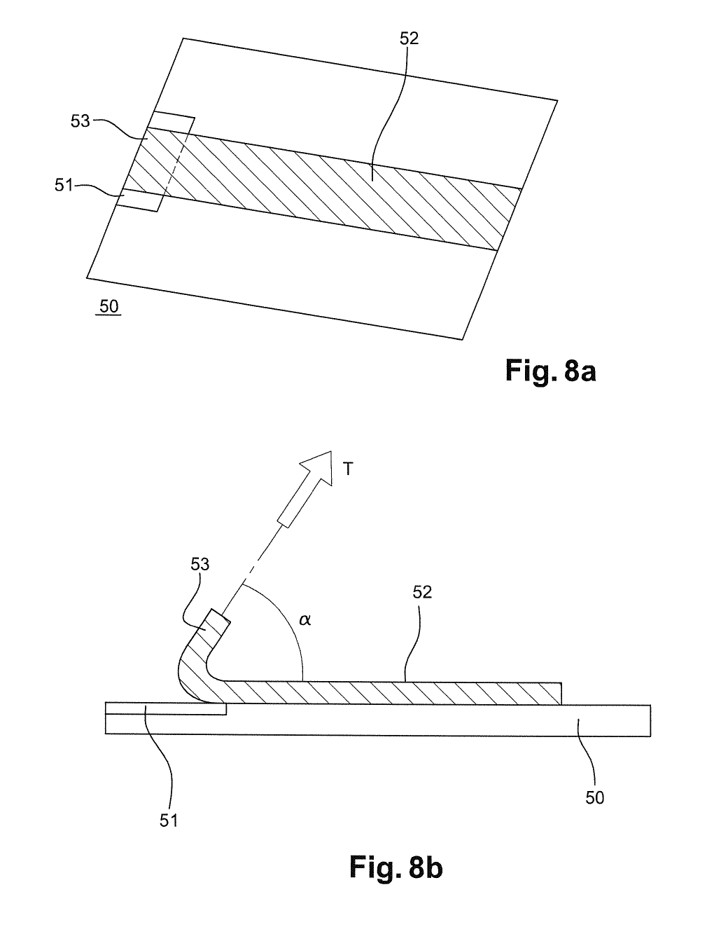

FIG. 8a represents a schematic view of a test sample for use in a peeling test;

FIG. 8b represents a schematic view of the procedure for a peeling test.

The threaded connection represented in FIG. 1 comprises a first tubular component with an axis of revolution 10 provided with a male end 1, and a second tubular component with an axis of revolution 10 provided with a female end 2. The two ends 1 and 2 each terminate in a terminal surface which is radially orientated with respect to the axis 10 of the threaded connection and are respectively provided with threaded portions 3 and 4 which cooperate together for mutual connection of the two components by makeup. The threaded portions 3 and 4 may be of the trapezoidal thread or other type. In the example shown, the threaded portions have threads with vanishing profiles at the respective ends of the threaded portions. These vanishing profiles extend over a portion of the axial extent of the threaded portion. In particular, a portion of the threaded portion with a vanishing profile 11 does not cooperate with a complementary threading.

In addition, the metal/metal sealing surfaces 5, 6 which are intended to come into sealed interfering contact with each other after connection of the two threaded components by makeup are respectively provided on the male and female ends close to the threaded portions 3, 4. Finally, the male end 1 terminates in a terminal surface 7 which comes into abutment against a corresponding surface 8 provided on the female end 2 when the two ends are made up one into the other.

As can be seen in FIG. 3, the male threaded portion 3 at the end 1 of a tubular component is at least partially coated with a strippable film 12 in accordance with the invention. This film 12 is intended to be removed to form the connection of the threaded connection described above. The threaded portion 3 can be produced on the perimeter of the tubular component, and so the film 12 preferably has the form of an external annular sleeve applied to the surface of the substrate formed by said threaded portion 3.

In the example shown, the film 12 is deposited on at least one thread of the threaded portion 3. In practice, the film 12 is deposited so as to cover the whole of the threaded portion 3, and preferably also the sealing surface 5, as well as on the terminal surface 7.

In a reciprocal manner, although this is not shown, a strippable film in accordance with the invention is also provided on the female threaded end 2 of a tubular component. In such a case, the strippable film will be deposited on the threaded portion 4, the sealing surface 6 and the terminal surface 8. In this case, the strippable film will form an annular inner sheath applied against the threaded end. Similarly, this strippable film will be capable of being removed before connecting the female threaded end 2 with a complementary end.

Ideally, the film 12 is deposited on the threaded portion in the form of a layer of substantially uniform thickness. In fact, the thickness of this layer fluctuates a little due to the particular shapes of the flanks of the thread carried by the threaded portion. FIG. 4 represents a detail of a thread of a threaded portion. Each thread thus comprises a load flank 13 forming an angle 14 in the range −5° to +5° with respect to the normal N to the axis 10 of the connection. The load flank is connected via a crest 15 to a stabbing flank 16. In particular, the connection shown is such that in the final position of the connection, the load flanks of the male threaded portion 3 are in contact with the corresponding load flanks of the female threaded portion 4.

Thus, it appears to be essential for the strippable film of the invention to be capable of being detached from the load flanks of the threaded portion.

The strippable film of the invention was produced, for example, from examples of the film precursor compositions defined as follows:

### EXAMPLE A

### Commercial Product: Corshield® VpCl® Strippable from Cortec

Composition A comprised one or more acrylic polymers or copolymers in aqueous dispersion, a corrosion inhibitor, a mineral filler such as a barium sulphate, a mould release agent, a dispersing agent and a thickening agent. The composition of Example A was characterized by a proportion of solid particles of 45%.

### EXAMPLE B

### Commercial Product: VpCl®-372 from Cortec

Composition B comprised an acrylic polymer or copolymer in aqueous dispersion, a corrosion inhibitor, a mould release agent, a dispersing agent and a thickening agent. The composition of Example B was characterized by a proportion of solid particles of 40%.

### EXAMPLE C

(the proportions are given as a % of the total weight of the liquid precursor composition).

| | |
|---|---|
| Polyester-polyurethane | 50% |
| IPA | 14% |
| Soya lecithin | 2% |
| Ammonium benzoate and sodium sulphonate | 3% |
| Thickening, preservative and anti-foaming agents | 1% |
| Demineralized water | qsp |

The composition of Example C was characterized by a proportion of solid particles of 30%.

### Preparation of Test Samples

Unless stipulated otherwise in the various test protocols described below, test samples were formed from a metallic plate covered with said strippable film. These intact samples were prepared from a plate with no rusting, namely corresponding to the score Re0 of ISO standard 4628. In particular, it was an XC48 low carbon steel as defined in the French standard. Each sample was produced from a flat rectangular metallic plate with the following dimensions: 150×100×0.8 mm. The surface of the plate had a roughness Ra of <1 μm.

The test samples were produced by depositing one or more superimposed layers of the same strippable film. The thickness of the layer was homogeneous over the whole of the plate.

The strippable film was applied using a pneumatic feed gun and cup for spraying the precursor film composition. The diameter of the nozzle of the gun must be in the range 0.7 to 1.8 mm and the minimum air pressure was 4 bars, preferably in the range 4 to 6 bars.

The temperature of the liquid precursor composition and the surface temperature of the metal plate were substantially identical, preferably in the range 5° C. to 35° C.

Coalescence and drying of a layer of the film was carried out at the application temperature for a period of 120 minutes before applying any second layer. Drying for 24 hours at ambient temperature allowed all of the residual water to be eliminated and completely guaranteed the properties of the film.

### Mechanical Characteristic Tests, Including Strippability

Initially, the investigators determined the mechanical properties of various films obtained from various compositions comprising polymers with differing characteristics.

In fact, a film is strippable if the mechanical and/or thermomechanical properties of the film, namely breaking strength and tensile strength, and glass transition temperature, allow it to do so. Too low a tensile strength might be deleterious to the “strippability” of a film, while too much elongation has to be compensated for by low adhesion to the support in order to guarantee good “strippability”. Low adhesion to the support could be adjusted with a mould release agent. A glass transition temperature that is much higher than the loading temperatures would be deleterious.

The mechanical properties of tensile strength and elongation at break of the various films were evaluated by a tensile test on tensile specimens 40, which were different from the test samples defined above, for which the strippable film had been prepared by forming a single layer with a thickness of 75 μm.

The tensile test was carried out using a MTS-2/M apparatus in accordance with standard NF T 51-304. H2 type tensile specimens 40 as described in FIG. 5 were cut out. The dimensions of the specimen are defined by the following dimensions: h=30 mm, I₁=13 mm, Lc=30 mm and I₀=4 mm. The draw rate V was 100 mm/minute and the ambient temperature was 20° C. The increasing force which was exerted meant that the Young's modulus and elongation could be measured.

The glass transition temperature of the film which was formed was measured by scanning differential calorimetry using a method comprising a first temperature ramp-up to 120° C., cooling to −100° C. and a second temperature ramp-up to 150° C. The rate of temperature rise and cooling was 25° C./min.

The strippability was evaluated by means of a stripping test carried out manually on test samples prepared as indicated above, and the results were interpreted using the sensorial evaluation grid below:
easy manual stripping is denoted 0;
stripping which is difficult to carry out without cohesive rupture of the film is denoted 1;
partial manual stripping with cohesive rupture, and thus tearing of the film into several pieces, is denoted 2;
no manual stripping possible is denoted 3.

Easy manual stripping is synonymous with a peeling force of less than 2 N/mm. The peeling force represents the force to be applied to ensure only adhesive rupture at the metal-film interface or coating-film interface.

The results allowing the minimum characteristics or acceptance thresholds to be determined in order to guarantee good strippability are recorded in Table 1.

TABLE 1

| Precursor | | | | |
|---|---|---|---|---|
| composition | Glass | | | |
| of | transition | Tensile | Elongation | |
| strippable | temperature | strength | at break | |
| film | (Tg) | (MPa) | (%) | Strippability |
| A | −10° C.; +35° C. | 1 | 570 | 1 |
| B | +12° C. | 10 | 1075 | 0 |
| C | −10° C. | 10 | 1600 | 0 |

The investigators also determined the influence of thickness and the number of layers on the mechanical properties of two compositions, A and B. The results are shown in Table 2. When the test sample comprised a film of 2 or more layers, each of the layers was of identical thickness.

TABLE 2

| Precursor | | | | | |
|---|---|---|---|---|---|
| composition | | | | | |
| of | Number | Total | Tensile | | |
| strippable | of | thickness | strength | Elongation at | Strip- |
| film | layers | (μm) | (MPa) | break (%) | pability |
| A | 1 | 50 | 0.7 ± 0.1 | 410 ± 150 | 2 |
| A | 1 | 75 | 1.06 ± 0.15 | 570 ± 110 | 2 |
| A | 1 | 125 | 1.4 ± 0.16 | 730 ± 75 | 1 |
| A | 2 | 140 | 0.3 ± 0.04 | 965 ± 160 | 1 |
| B | 1 | 75 | 10 ± 1 | 1075 ± 30 | 0 |
| B | 1 | 120 | 10.7 ± 0.6 | 1060 ± 10 | 0 |
| B | 2 | 180 | 9.6 ± 1.4 | 1090 ± 45 | 0 |

Given a satisfactory strippability, with a score of 0, increasing the thickness and the number of layers did not affect the strippability score. In contrast, it was observed that for composition A, an increase in thickness beyond 125 μm and of the number of layers beyond 2 layers improved the strippability score.

The peeling force was determined from a peeling test carried out at ambient temperature (20° C.) using a CETR tribometer and the equipment and conditions described in FIGS. 8a and 8b. The rate of translation was 14 mm/s and the peeling force was expressed in N/mm. In general, conventional peeling test rates are in the range 5 to 80 mm/s for an adhesive, and thus 14 mm/s was sufficiently pertinent.

In order to carry out this peeling test, panels of the type shown in FIG. 8a were used. These panels 50 were rectangular in shape and formed from XC48 steel and had a zone 51 covered with a PTFE film preventing adhesion of the strippable film deposited in that zone. The strippable film to be tested was deposited in the form of a strip 52, such that one end 53 of the film overlaid the zone 51 and was thus free and capable of being gripped. During the test, the panels were kept in a fixed position while tweezers were used to grip the free end 53 and incline it at an angle α of the order of 45° with respect to the panel 50 and exert tension in the direction of the arrow T indicated in FIG. 8b.

A peeling test was carried out with the strippable film with composition B, applied in two layers of identical thickness and forming a film with a total thickness of 150 μm. This peeling test was carried out on supports not comprising an intermediate dry lubricant coating, see the first two rows of Table 3, and also on supports comprising such a coating, see the last three rows of Table 3 below.

TABLE 3

| | Peeling force |
|---|---|
| Support | (N/mm) |
| XC48 steel (as machined) | 0.014 |
| XC48 steel which has undergone a manganese | 0.092 |
| phosphatization treatment | |
| XC48 steel which has undergone a manganese | 0.047 |
| phosphatization treatment and is covered with a | |
| layer with composition No 1 | |
| XC48 steel coated with an electrolytic deposit of | 0.031 |
| a ternary CuSnZn alloy comprising an underlay | |
| of Wood's nickel and covered with a layer of | |
| composition No 3 | |
| XC48 steel which has undergone a zinc | 0.028 |
| phosphatization treatment and is covered with | |
| composition No 4 | |

In all cases, the measured peeling force was less than 2 N/mm, or preferably less than 1 N/mm, and more preferably less than 0.2 N/mm. Table 3 below demonstrates the compatibility and facility of peeling of a strippable film with composition B under various conditions.

For the purposes of the invention, sufficient mechanical properties for a strippable film are an elongation at break of more than 700%, preferably more than 1000%, and a tensile strength of more than 1 MPa, preferably 10 MPa or more.

### Corrosion Resistance Test on Test Samples

A strippable film of the invention passes the corrosion resistance test by having excellent resistance as defined by the classification of ISO standard 4628: no corrosion, no blistering, no cracking, and no flaking.

The plate of XC48 low carbon steel coated with a strippable film was exposed to a neutral saline spray as described in ISO standard 9227. This test was carried out in a climatic chamber. The conditions in the climatic chamber were as follows: 35° C., with a 50 g/L saline solution, with a density in the range 1.029 to 1.036 at 25° C., a pH in the range 6.5 to 7.2 at 25° C. and recovered at a mean rate of 1.5 mL/h. The test samples were placed in a support at an angle of 20° in order to maximize their exposure.

The results presented in Table 4 below highlight the importance of thickness and the favourable factor of multiple superimposed layers.

TABLE 4

| | | | Saline spray exposure time | | | |
|---|---|---|---|---|---|---|
| | | | 72 hours | 168 hours | 336 hours | 504 hours |
| Reference with no strippable film: | | | Re9 | — | — | — |
| Bare XC48 carbon steel | | | | | | |
| Composition | Number of | Total | | | | |
| of strippable | layers of | thickness of | | | | |
| film | strippable | strippable | | | | |
| precursor | film | film (μm) | | | | |
| B | 1 | 25 | Re3 | Re4 | Re7 | Re9 |
| B | 1 | 50 | Re2 | Re3 | Re6 | Re7 |
| B | 2 | 75 | Re0 | Re1 | Re2 | Re4 |
| B | 2 | 150 | Re0 | Re0 | Re0 | Re1 |

Table 5 below collects the results obtained for samples comprising a layer of a dry solid lubricating coating with composition No 5. For the test samples, the metallic low carbon XC48 steel plate had undergone a surface treatment such as manganese phosphatization in order to promote keying of the layer of lubricating coating. This layer of lubricating coating, disposed between the metallic plate and various compositions of strippable film, had a total thickness of 35 μm.

TABLE 5

| Composition | Number of | Total | | | | |
|---|---|---|---|---|---|---|
| of strippable | layers of | thickness of | | | | |
| film | strippable | strippable | Saline spray exposure time | | | |
| precursor | film | film (μm) | 72 hours | 168 hours | 336 hours | 504 hours |
| Reference with no strippable film | | | Re0 | Re0 | Re1 | Re2 |
| A | 1 | 70 | Re0 | Re0 | Re0 | Re0 |
| A | 2 | 120 | Re0 | Re0 | Re0 | Re0 |
| B | 1 | 50 | Re0 | Re1 | Re1 | Re2 |
| B | 2 | 80 | Re0 | Re0 | Re0 | Re0 |

For the tests carried out with the strippable film with composition A, a slight detachment was observed after 504 hours of saline spray exposure. Advantageously, the barrier property of the strippable film and the reaction processes of the corrosion inhibitors constituting the strippable film means that the mechanism of corrosion of a lubricating coating already present on a connection can be considerably inhibited or retarded if the thickness and the number of layers is appropriate.

For the purposes of the invention, deposition of at least two layers of a film with a total thickness of more than 75 μm is preferable in order to limit initiation of corrosion, irrespective of the support.

Corrosion Resistance Test on Tubular Component with the Threaded Portion Covered with a Strippable Film.

A full scale test was also carried out by considering tubular components of L80 steel with a VAM 21® threading with an external diameter of 7″ and for which the female threaded portion was coated with a strippable film with composition B in a single layer 100 μm in thickness.

Prior to deposition of the strippable film, a conversion treatment was carried out on the threaded portion. This was manganese phosphatization at a thickness in the range 5 to 10 μm and with a maximum ridge depth, or Rz, of 10 μm.

The tubular components were exposed to oceanic and industrial climatic conditions. The threaded portion coated with said strippable film was not covered with an additional protective means, so that the strippable film was directly exposed to the external conditions.

No rusting and no defects were observed after 6 months' storage under such conditions, while the same threaded portion which had not been covered with this strippable film was partially or completely corroded after one month under such storage conditions.

No rusting was observed on tubular components comprising a dry solid lubricating coating, for example that with composition No 5 defined above, deposited between the threaded portion and the strippable film, provided that the strippable film comprised two layers as indicated in Table 5.

### Test of Strippable Film Adhesion, Known as the “Scratch” Test

The test described, or scratch test, can be used to evaluate the adhesive force or adhesion of a coating on a surface. The method consists of deforming the strippable film of a test sample produced with an intermediate layer of dry lubricant, and of evaluating the impact of deposition and removal of the strippable film onto and from the intermediate layer of dry lubricant. In fact, the lubricating character of a coating is generally evaluated by means of its coefficient of friction. Thus, it is possible to evaluate whether, in addition to protection from corrosion, the strippable film can maintain the lubricating properties of the intermediate layer during storage.

The test, which is represented in FIG. 6, was carried out with a spherical bead 30 formed from tungsten carbide, with a diameter of 5 mm, translated over the film 12 at a velocity V of 2 mm/s and subjected to an increasing load F from 10 N to 310 N at a load increase rate of 15 N/s, in order to measure the coefficient of friction of the dry lubricant material L deposited between the plate P and the strippable film 12, both before depositing the strippable film and after removing the strippable film. The test lasts 20 seconds, which is the time taken by the bead to travel over the 40 mm track.

The coefficient of friction was at least 40% higher for a strippable film with composition A. For all of the strippable films tested with the precursor compositions B and C for which the elongation at break is more than 1000%, it has advantageously been demonstrated that the coefficient of friction of the intermediate dry lubricant composition did not vary, and thus its properties were maintained despite depositing and removing the strippable film, as can be seen in Table 6.

TABLE 6

| | | Total | Layer of lubricating coatings | | |
|---|---|---|---|---|---|
| Strippable | Number | thick- | 35 μm in thickness | | |
| film | of | ness | Compo- | Compo- | Compo- |
| precursor | layers of | (μm) of | sition | sition | sition |
| composi- | strippable | strippable | No 1 | No 2 | No 3 |
| tion | film | film | CoF | CoF | CoF |
| Reference before depositing | | | 0.07 | 0.08 | 0.14 |
| a strippable film | | | | | |
| A | 2 | 120 | 0.12 | 0.11 | NA |
| B | 2 | 150 | 0.07 | 0.08 | 0.14 |
| C | 2 | 100 | 0.07 | 0.08 | 0.14 |

CoF = coefficient of friction

Advantageously, then, it was decided that the threaded portion of a tubular component which had been freshly machined in step E1 of FIG. 7 would be protected by carrying out the following steps in succession:
depositing a dry lubricating composition in step E2;
depositing a strippable film in accordance with the invention in step E3;
positioning an additional protective device, such as a protective sleeve, in step E4;
storing for several weeks, months or years subjected to external climatic conditions in step E5;
removing the additional protective device in step E6, when use of the tubular component is envisaged;
manually removing the strippable film in step E7, while preserving the mechanical qualities of the dry lubricant layer;
recycling the strippable film in step E8; and finally
completing a threaded connection of the tubular component with a complementary tubular component in step E9.

The advantage of the invention lies in proposing an effective means for protection against corrosion which is easy to eliminate and which can facilitate and shorten the duration of steps E7 to E9.

1-20. (canceled)

21. A tubular component comprising:
at least one threaded portion for connecting the component with a complementary component,
wherein at least a portion of the threaded portion is coated with a strippable film which protects against corrosion.

22. A tubular component according to claim 21, wherein a precursor composition for forming the strippable film comprises an aqueous dispersion of a film-forming polymer, the film-forming polymer being selected from natural or synthetic latexes, acrylic resins, acrylic copolymers such as styrene-acrylates, butadiene-acrylates, vinyl chloride-acrylates, polyvinylidene chloride-acrylates, vinyl acetate-acrylates, polyvinyl-styrene butadiene copolymers, polyvinyl butyrals, polyisocyanates, polycondensate type aliphatic polyurethanes such as anionic, cationic, non-ionic or amphoteric polyurethanes, acrylic polyurethanes, polyester-polyurethanes, and mixtures thereof.

23. A tubular component according to claim 21, wherein the strippable film has a glass transition temperature in a range of −10° C. to +35° C.

24. A tubular component according to claim 21, wherein the strippable film comprises a corrosion inhibitor, or selected from an alkaline salt of an alkylarylsulphonic acid, the alkaline compound being a barium, a calcium, a magnesium or a sodium compound, or from volatile organic nitrogen-containing molecules, or selected from an aliphatic amine (hexamethylene diamine, monoethanolamine), an amine carboxylate complex (monoethanolamine borate, cinnamic acid hexamethylenediamine, capric acid dicyclohexylamine, polyaspartic acid-imidazoline), a benzotriazole, an ammonium benzoate or a sodium nitrite, or an inorganic corrosion inhibitor, for example selected from a hydrated zinc and aluminium orthophosphate, a hydrated zinc and molybdenum orthophosphate, a hydrated strontium and aluminium polyphosphate, a hydrated zinc and calcium and strontium orthophosphate silicate, a zinc and iron phosphate, a zinc, calcium and strontium phosphosilicate, a zinc orthophosphate, an aluminium triphosphate, a zinc molybdate coupled with zinc phosphate-modified agents, a sodium molybdate, a calcium metaborate, a barium metaborate, a calcium borosilicate, a calcium ion exchanged silica, and mixtures thereof.

25. A tubular component according to claim 21, wherein the strippable film comprises a thixotropic thickening agent, or selected from a modified hydrophobic polyacrylate or a hydroxyethylmethylcellulose.

26. A tubular component according to claim 21, wherein the strippable film comprises a mold release agent, or selected from cyclopentasiloxane and soya lecithin.

27. A tubular component according to claim 21, wherein the strippable film comprises a plasticizing agent, or from the list formed by polyvinyl alcohols, polyglycols, celluloses and glycerol.

28. A tubular component according to claim 21, wherein the strippable film comprises a hydrosoluble polar solvent, or selected from methanol, butanol and isopropanol (IPA).

29. A tubular component according to claim 21, wherein the strippable film comprises a polymer comprising particles with a size in a range of 50 to 200 nm.

30. A tubular component according to claim 21, wherein the strippable film comprises a coloring agent.

31. A tubular component according to claim 21, wherein the strippable film has a tensile strength of more than 1 MPa, or more than 10 MPa.

32. A tubular component according to claim 21, wherein the strippable film comprises an elongation at break of more than 300%, or more than 700%, or more than 1000%.

33. A tubular component according to claim 21, wherein the strippable film has a peeling resistance of less than 2 N/mm.

34. A tubular component according to claim 21, further comprising a layer of dry lubricating composition disposed between the threaded portion and the strippable film.

35. A method for preparation of a threaded end of a tubular component comprising depositing a strippable film by spraying a liquid precursor composition of the strippable film.

36. A preparation method according to claim 35, wherein the liquid precursor composition is sprayed at a temperature in a range of 20° C. to 40° C.

37. A preparation method according to claim 35, wherein a temperature at which the liquid precursor composition is sprayed is selected to be substantially identical to surface temperature of the tubular component.

38. A preparation method according to claim 35, wherein the film is deposited in at least two superimposed layers.

39. A preparation method according to claim 35, wherein prior to depositing the strippable film, the threaded portion is covered with a dry lubricating composition.

40. A preparation method according to claim 35, wherein prior to depositing the strippable film, and if appropriate prior to depositing the dry lubricating composition, a surface treatment of the threaded portion is carried out, either by mechanical sand blasting or by zinc or manganese phosphatization, or by an electrolytic deposition of a ternary CuSnZn alloy comprising an underlay of Wood's nickel.
